(19) United States
(12) Patent Application Publication
(10) Pub. No.: US 2024/0241635 A1
(43) Pub. Date: Jul. 18, 2024

(54) ONE-HANDED OPERATION OF A DEVICE USER INTERFACE

(71) Applicant: Telefonaktiebolaget LM Ericsson (publ), Stockholm (SE)

(72) Inventors: Fredrik Dahlgren, LUND (SE); Alexander Hunt, TYGELSJÖ (SE); Andreas Kristensson, SÖDRA SANDBY (SE)

(21) Appl. No.: 18/562,307

(22) PCT Filed: May 27, 2021
(86) PCT No.: PCT/EP2021/064296

§ 371 Date: Nov. 18, 2023

(51) Int. Cl. G06F 3/0488; G06F 3/041; G06F 3/0481; G06F 3/0484; G06F 3/16

(52) U.S. Cl. CPC G06F 3/0488; G06F 3/0416; G06F 3/0481; G06F 3/0484; G06F 3/167; G06F 2203/04101

(57) ABSTRACT

Operation of a user interface of a device that has a hover and touch sensitive display device includes receiving user information from the hover and touch sensitive display device and detecting that the received information corresponds to a hover control gesture, wherein the hover control gesture comprises a swipe gesture followed by hover information. In response to the detecting, the device is operated in a hover control mode that comprises using continuously supplied hover information to control placement of a cursor display on the hover and touch sensitive display device.

### BACKGROUND

The present invention relates to technology that enables a user to operate a handheld device having a display, and more particularly to technology that enables a user to use one hand to simultaneously hold and operate a handheld device having a display.

Today's smartphones have touchscreens that not only display information to a user, but also enable the user to supply input to the device, such as selections and data. The user interacts with touchscreens primarily by touching the display with one or more fingers. However in the general case, touch interaction can have many types of gestural inputs (micro-interactions) such as tap, double-tap, slide, tap-slide, tap-hold, swipe, flip, pinch, and the like.

Inputting information in this way is very simple and accurate when the user holds the phone with one hand while interacting with the touchscreen with the other. Quite often, however, the user is holding the smartphone with one hand while the other hand is busy doing other things, for example, carrying a bag or similar. Relatively long ago, when phones were small and had physical buttons only on parts of the front surface, it was relatively easy for most people to use just one hand to both operate the phone and hold it (i.e., one-handed operation). However, with today's large phones, this is very difficult with the touch-based User Interface (UI) and it is consequently quite common that people drop the phone while trying to do so. For this reason, there have been various attempts to solve this problem.

For example, in some of today's smartphones, it is possible to activate one-handed operation through the settings-menu, whereby the complete display content is scaled down to a sub-area of the display which can then be reached by, for example, the thumb of the hand holding the phone. In that solution, the content becomes smaller as the same content fit into only a subset of the display.

In a different approach, US 2014/0380209 A1 describes technology in which the complete display content is shifted so that each displayed item retains its original size but with only parts of the content being shown.

In still another approach, U.S. Pat. No. 10,162,520 B2 describes technology in which a keyboard on the touchscreen is re-sized into a limited area of the display screen that is reachable by the thumb of the one hand holding the smartphone.

Currently, there are different sensors that can detect movements above or at the side of a handheld device (e.g., a smartphone). For example, US 2014/0267142 A1 describes touch or multi-touch actions being continued or extended off-screen via integrating touch sensor data with touchless gesture data. Sensors providing such functionality include radar, cameras on the side of the smartphone, infrared, and the like. As described in an article accessible at the URL en.wikipedia.org/wiki/Google_ATAP, project Soli involves development of a radar-based gesture recognition technology. There are different technologies (e.g., radar, ultra-sound, capacitive, light etc.) for detecting proximity and distance between the phone and an object above the phone.

The sensor-based solutions to the problem of one-handed device operation, such as those mentioned above, do not explicitly address the problem of one-handed operation. For example, the technology described in US 2014/0267142 is intended to sense activities aside the phone, and hence is suitable for two-handed operation. Many of the gesture-based technologies such as employed by project Soli are similar in that they detect gestures by hands that are separated from the mobile device.

Technologies that re-scale the display content are problematic in that they make the content more difficult to read, and this might limit the user experience when a person needs to employ the technology (e.g., when only able to use one hand due to being in transit).

Furthermore, technologies such as that which is described in US 2014/0380209 A1, in which only a subset of the display content is visible, might be problematic.

And technologies such as that which is described in U.S. Pat. No. 10,162,520 B2 are limited to certain use cases and are limiting as to which applications are adapted. This is then more limiting and disruptive to the user experience.

All of above-mentioned technologies are less flexible in that different positions of the hand lead to different reachability of the thumb.

There is therefore a need for technology that addresses the above and/or related problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) in which a user interface of a device is operated, wherein the user interface comprises a hover and touch sensitive display device. The operation comprises receiving user information from the hover and touch sensitive display device and detecting that the received information corresponds to a hover control gesture, wherein the hover control gesture comprises a swipe gesture followed by hover information. In response to the detecting, the device is operated in a hover control mode that comprises using continuously supplied hover information to control placement of a cursor display on the hover and touch sensitive display device.

In another aspect of some but not necessarily all embodiments consistent with the invention, an initial placement of the cursor display following the detecting is a detected location at which a first object performing the swipe gesture lifted off of the hover and touch sensitive display device.

In yet another aspect of some but not necessarily all embodiments consistent with the invention, using the continuously supplied hover information to control placement of the cursor display on the hover and touch sensitive display device comprises moving the cursor display in one of two directions along a line of movement in correspondence with a trajectory of the detected swipe gesture, wherein a placement of the cursor display along the line of movement is proportional to a detected height of the first object from the hover and touch sensitive display device.

In still another aspect of some but not necessarily all embodiments consistent with the invention, the placement of the cursor display along the line of movement is continuously adjusted in correspondence with changes in detected height of the first object from the hover and touch sensitive display device. In some but not necessarily all such embodiments, the placement of the cursor display along the line of movement is continuously adjusted further in correspondence with a speed at which detected height of the first object from the hover and touch sensitive display device changes.

In another aspect of some but not necessarily all embodiments consistent with the invention, operation includes detecting that the hover information indicates a movement of the object parallel to a plane of the hover and touch sensitive display device, and in response thereto adjusting the placement of the cursor display in a direction that is orthogonal to the line of movement. In some but not necessarily all such embodiments, adjusting the placement of the cursor display in the direction that is orthogonal to the line of movement comprises adjusting the placement of the cursor display in the direction that is orthogonal to the line of movement by an amount that is proportional to an amount of movement of the object that is parallel to the plane of the hover and touch sensitive display device.

In yet another aspect of some but not necessarily all embodiments consistent with the invention, operation comprises one of:
estimating the trajectory from input touch information obtained over a predefined distance of the hover and touch sensitive display device; and
estimating the trajectory from input touch information obtained over a predefined period of time.

In still another aspect of some but not necessarily all embodiments consistent with the invention, operation comprises using radar information to detect the height of the first object from the hover and touch sensitive display device.

In another aspect of some but not necessarily all embodiments consistent with the invention, operation comprises, while in hover control mode, detecting that the cursor display is pointing to an executable function of the device when a first predefined number of taps on the device by a second object is detected, and in response thereto causing the device to perform the executable function.

In yet another aspect of some but not necessarily all embodiments consistent with the invention, operating the device in the hover control mode is enabled in response to a detection of a predefined enabling user input to the device.

In still another aspect of some but not necessarily all embodiments consistent with the invention, the predefined enabling user input to the device comprises any one or more of:
input generated by a swipe movement from a bottom point to a second point on the hover and touch sensitive display device followed by a second predefined number of taps on the device by a second object;
input generated by a first swipe movement followed by a second swipe movement;
input generated by a predefined movement of the device while maintaining the first object on the hover and touch sensitive display device; and
input generated by analysis of voice input.

In another aspect of some but not necessarily all embodiments consistent with the invention, operation of the device comprises causing operation of the device to leave the hover control mode in response to detecting that the first object is touching the hover and touch sensitive display device.

### BRIEF DESCRIPTION OF THE DRAWINGS

The objects and advantages of the invention will be understood by reading the following detailed description in conjunction with the drawings in which:

FIGS. 1A and 1B depict, from different angles, a hover and touch sensitive display device of a user device and a hover control gesture that can be applied to such a device in accordance with inventive embodiments.

FIG. 2 illustrates a device having a hover and touch sensitive display device on front surface of the device.

FIG. 3 is in one respect a flowchart of actions taken by a device to enter and operate in a hover control mode that enables one-handed operation of the device.

FIG. 4 is, in one respect, a flowchart of some actions taken by the device to enter and operate in a hover control mode that enables one-handed operation of the device.

FIGS. 5A and 5B illustrate one or more touch areas that are defined as a capacitive proximity sensor.

FIG. 6 is a block diagram of an exemplary controller of a device in accordance with some but not necessarily all exemplary embodiments consistent with the invention.

### DETAILED DESCRIPTION

The various features of the invention will now be described in connection with a number of exemplary embodiments with reference to the figures, in which like parts are identified with the same reference characters.

To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

In one aspect of embodiments consistent with the invention, the technology involves a device having a user interface comprising a hover and touch sensitive display device. The hover and touch sensitive display device can comprise, for example, one or multiple sensors (e.g., capacitive proximity, ultra-sound, radar, and the like) capable of detecting the distance of an object (e.g., a finger) above the display surface. In some but not necessarily all inventive embodiments, the sensor may also be capable of detecting a gesture (e.g., that the object is moving to the left or the right when it is above the hover and touch sensitive device). In some but not necessarily all inventive embodiments, the device further comprises an Inertial Motion Unit (IMU) capable of detecting rapid movements of the device itself.

In another aspect of embodiments consistent with the invention, when the device is held with one hand, having for example the thumb above the touchscreen for one-handed operation with touch control, the device is capable of detecting that a swipe movement performed on the display surface was followed by the lifting of the thumb. The swipe movement forms a trajectory on the screen. When the thumb lifts from the display, a cursor indicates the place where it was at the point of liftoff, and as the thumb lifts more and more from the display, the cursor continues along the trajectory proportionally to the thumb's distance from the screen. If the thumb lowers again, the cursor moves back accordingly.

In yet another aspect of some but not necessarily all embodiments consistent with the invention, the activation of a function that the cursor is pointing to is triggered by a tap or a double tap on the phone by any of the other fingers holding the phone (e.g., detected by the IMU).

In still another aspect of some but not necessarily all embodiments consistent with the invention, the cursor can be controlled left/right from the trajectory by detecting and responding to thumb movements made to the left/right as the thumb is held above the screen.

In yet other aspects of some but not necessarily all embodiments consistent with the invention, the one-handed mode of operation can be activated and/or deactivated in a number of different ways. These and other aspects are discussed in greater detail in the following.

In one exemplary, non-limiting example, a system consistent with the invention comprises at least one device (e.g., a smartphone) having at least some but not necessarily all of the following characteristics:
A touchscreen configured to detect finger movements and process the information accordingly in a manner that has a meaning, such as navigating in an application (“app”) or menu, such as are deployed in a typical smartphone device.
A sensor capable of detecting the distance of an object (e.g., finger) above the touchscreen, e.g. ultrasound, radar, and the like.
An IMU or accelerometer capable of detecting a rapid movement such as one produced by a tap of a finger on the device.

In embodiments consistent with the invention, the user interface (UI) of a device is controlled by detected interactions between a hover and touch sensitive display of the device and an object. In most circumstances, the object will be a finger (a term used herein to include any of the four fingers and opposable thumb of a hand) of the user, and in most of those circumstances, the thumb will be used because, for most people, the thumb is the most natural digit/object for performing the described gestures and movements. Accordingly, in the following descriptions, the thumb is described as the finger/object controlling the UI. However, this is done merely for purposes of illustration. Those of ordinary skill in the art will readily appreciate that any finger and even some objects (e.g., stylus) can be used as the object in place of the thumb.

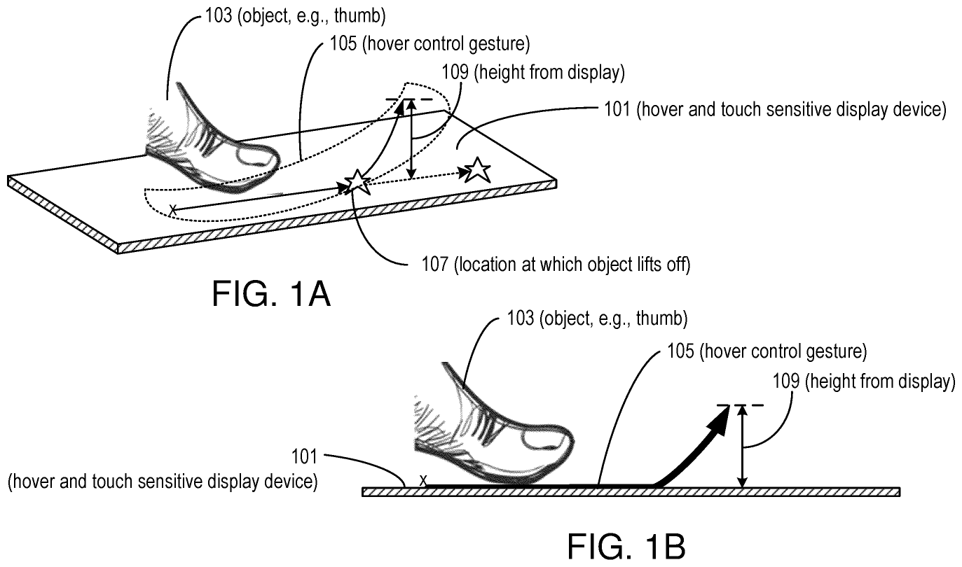

FIG. 1A depicts a hover and touch sensitive display device 101 of a user device (e.g., smartphone—not shown in order to avoid cluttering the figure). An object (e.g., user's thumb) 103 starts touching the screen at a point indicated by “X”, and performs a hover control gesture 105. The hover control gesture 103 comprises the object 103 making a swipe movement from the starting point “X” to a location 107 at which the object 103 lifts off from the device surface, and then continuing to rise to a height 109 above the hover and touch sensitive display device 101. The device is configured to respond to the hover control gesture 105 by causing a cursor to appear on the screen of the hover and touch sensitive display device 101 at the position 107 at which liftoff occurred, and to continue moving along the trajectory that the object 103 had before it was lifted.

In another aspect, the device is configured to cause the displayed cursor to remain still in response to the object 103 becoming still while hovering above the hover and touch sensitive display device 101.

In still another aspect, as the object 103 is raised or lowered, the cursor moves accordingly forward or backward along the trajectory and by an amount that is proportional to the distance between the object 103 and the hover and touch sensitive display device 101.

FIG. 1B illustrates some of the same features and the same activity but from the side, clearly showing that the object 103 initially makes a hover control gesture 105 that comprises a movement on the device 101 followed by a lifting above the device 101.

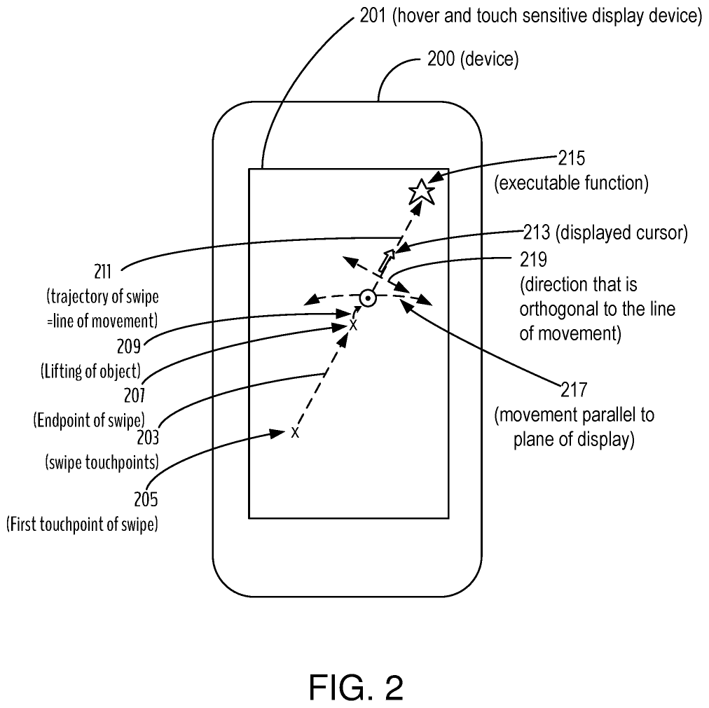

To further illustrate aspects of embodiments consistent with the invention, FIG. 2 illustrates a device 200 having a hover and touch sensitive display device 201 on front surface of the device 200. The perspective adopted in FIG. 2 is of the device 200 as seen from above the hover and touch sensitive display device 201. Components of the hover control gesture 105 are illustrated. In particular, an object (e.g., thumb) 103 makes a swipe gesture 203 starting at a first touch point 205 on the hover and touch sensitive display device 201 and extending to an endpoint 207. From the endpoint 207 the object lifts 209 into the air.

The device 200 is configured to detect that the hover control gesture 105 has been performed, and to respond to the detection by determining a trajectory 211 of the swipe 207 and also by displaying a cursor 213 initially at the point of liftoff 209. The cursor 213 does not remain at its position 207 at the point of liftoff 209, however, but instead moves along the trajectory 211 of the swipe 203 by an amount that is proportional to the object's height 109 above the hover and touch sensitive display device 201. The cursor accordingly moves forward or backwards along the trajectory 211 in correspondence with the object moving higher or lower above the hover and touch sensitive display device 201.

In another aspect of embodiments consistent with the invention, by moving the object up or down above the hover and touch sensitive display device 201, the user can cause the cursor 213 to move to an indicated executable function 215 that is displayed on the hover and touch sensitive display device 201. At this point, if any of the other fingers currently on the device 200 makes a tap (e.g., detected by the device's IMU), the executable function 215 pointed to by the cursor 213 is activated. Certain functions might require a double tap before activation is initiated, depending on the UI, app, or context.

In a further aspect of some but not necessarily all embodiments, sensors (for example radar) of the device 200 can detect not only the distance between the object 103 and the hover and touch sensitive display device 201, but also movements of the object 103 in the air that are parallel to the plane of the hover and touch sensitive display device 201 (e.g., movements to the right or left as seen from above the device 200). The device 200 is further configured to move the cursor 213 not only along the trajectory 211 according to the height 109, but also to the left or the right in a direction 219 that is orthogonal to the trajectory 211 in dependence on the object's movement. Consequently, the object 103 can control the exact position of the cursor 213 along two orthogonal axes when it is in the air.

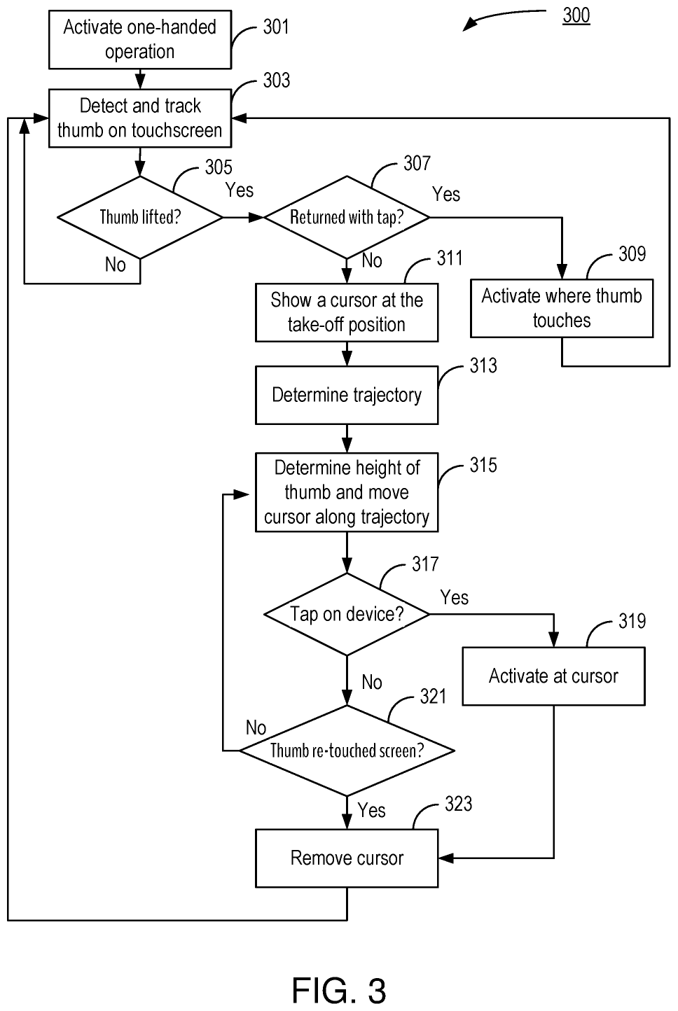

Further aspects of inventive embodiments will now be described with reference to FIG. 3, which is in one respect a flowchart of actions taken by the device 200 to enter and operate in a hover control mode that enables one-handed operation of the device 200. In other respects, the blocks depicted in FIG. 3 can also be considered to represent means 300 (e.g., hardwired or programmable circuitry or other processing means) for carrying out the described actions.

At step 301, one-handed operation is activated. Preferably, this is in response to a pre-defined trigger so that the device 200 will not behave in an unpredictable manner during normal two-handed operation. The trigger can be a predefined input pattern from the user, such as but not limited to an initial swipe movement of the thumb from the bottom to the center of the screen followed by a double tap of any of the other fingers. In alternative embodiments, the predefined triggering input can be other gestures or combination of gestures including but not limited to shaking or tilting the device back and forth while holding the thumb on the screen, or voice control.

At step 303, it is detected that an object (e.g., finger or thumb of the user) is touching the hover and touch sensitive display device 201. This is an ordinary touch-based user interface in the area reachable by, for example, the user's thumb. As long as the thumb is still touching the screen, the device operates in accordance with the principles of the ordinary touch-screen user interface.

In some but not necessarily all embodiments, part of the movement on the screen is recorded for a subsequent trajectory estimation. Alternatively, the current trajectory is estimated as the thumb moves on the screen in performance of the swipe gesture so that it is readily available.

As the object 103 is in contact with the screen, the device 200 checks to determine whether the object has been lifted (decision block 305). If not (“No” path out of decision block 305), processing reverts to step 303 and operation continues as described above.

But if it is detected that the object 103 has been lifted (“Yes” path out of decision block 305), this may indicate completion of the hover control gesture 105 and in response to the hover control gesture 105, the cursor 213 and function activation are controlled and operated as described above with reference to FIGS. 1A, 1B, and 2 to continue moving the cursor 213 to a point on the hover and touch sensitive display device 201 that is not reachable by a touch movement. However, lifting of the object 103 may alternatively have occurred because the user is in the process of tapping the screen at a present position of the thumb (e.g., to select or activate an indicated function).

To distinguish between the two possibilities, in the illustrated exemplary embodiment it is determined whether the object 103 has lifted above the screen and lowered again immediately (e.g., as determined by a certain amount of max time, e.g. 0.5 seconds, between liftoff and a second contact with the hover and touch sensitive display device 201) (decision block 307). If so (“Yes” path out of decision block 307), this is interpreted as a tap on the hover and touch sensitive display device 201, and operation follows conventional procedure in the case of a tap, for example by activating an executable function indicated at the point of contact (step 309). Processing then reverts back to step 303 and operation continues as discussed above.

However, if a tap on the device 200 is not detected (“No” path out of decision block 307), a cursor 213 is shown at the place where the thumb was (i.e., at the point of liftoff 107, 209) (step 311). Furthermore, the trajectory 211 of the latest thumb movement on the screen is determined (step 313).

The trajectory 211 can be determined in any of a number of different ways, and all are contemplated to be within the scope of inventive embodiments. For example, and without limitation:
The trajectory 211 can be based on the last movement of a certain distance on the screen (e.g., based on the last 10 mm of movement).
The trajectory 211 can be based on the duration of movement on the screen (e.g., the last 0.5 seconds of movement).
In some but not necessarily all embodiments, the trajectory 211 is determined as the object 103 moves in contact with the hover and touch sensitive display device 101, 201 and is therefore readily available when the object 103 lifts up.

While the object (e.g., thumb) 103 remains in the air above the surface of the hover and touch sensitive display device 101, 201, the trajectory 211 is used along with at least height information to control the location of the displayed cursor 213. more particularly, the height of the object relative the surface of the hover and touch sensitive display device 103, 203 is determined, and the position of the displayed cursor 213 is adjusted along the trajectory 211 in correspondence with the movement (step 315). For example, as the object 103 rises above the surface of the hover and touch sensitive display device 103, 203 (i.e., screen), the cursor 213 is moved along the trajectory 211 in proportion to the distance of the object 103 from the screen 103, 203. This proportionality can be linear, for example where 5 mm height of the thumb above the screen corresponds to 10 mm of movement on the screen, or it can alternatively be, for example, progressive whereby a faster thumb movement corresponds to a proportionally longer movement of the cursor 213. If the thumb 101 lowers, the cursor 213 returns accordingly, making the position of the cursor 213 along the trajectory 211 dependent on the height of the thumb above the screen (if the thumb is still, so is the cursor).

If the object (thumb) is lowered onto the hover and touch sensitive display device 101, 201, the cursor 213 disappears, and the operation reverts back to ordinary touchscreen behavior.

In some but not necessarily all embodiments consistent with the invention, sensors (for example radar) are used to detect not only the distance between the object 101 and the screen 103, 203 but also movement 217 of the object 101 in the air parallel to the plane of the hover and touch sensitive display device 103, 203. Such movement may be perceived by the user as being essentially to the right or to the left in the air, although it may actually traverse an arc. The movement 217 includes a component in a direction 219 that is orthogonal to the trajectory 211, and this information is used to control movement of the cursor 213 as well. In particular, the cursor 213 moves along the trajectory 211 according to the height 109, and also to the left or the right along the direction 219 that is orthogonal to the trajectory 211, both being in dependence on the object's (e.g., thumb's) movement. Hence, the object (thumb) 101 can control the exact position of the cursor 213 when it is in the air, without being limited to only movements along the trajectory 211.

In another aspect of embodiments consistent with the invention, it is possible to select/activate an executable function 215 in one-handed mode. To do this, information from one or more sensors is used to detect (decision block 317) whether a tap on the device 200 has occurred (e.g., by the user tapping on the back of the device 200 with one or more fingers). If a tap is detected (“Yes” path out of decision block 317), the executable function 215 pointed to by the cursor 213 is activated (step 319). The cursor is then removed (step 323) and operation of the device 200 is controlled by the activated function.

If no tap was detected (“No” path out of decision block 317), it is determined (decision block 321) whether the object 103 has again come into contact with (e.g., again resting on) the hover and touch sensitive display device 103, 203. If not (“No” path out of decision block 321), processing reverts back to step 315 and operation continues as described above.

If it is detected that the object 103 has again come into contact with (e.g., is again resting on) the hover and touch sensitive display device 103, 203 (“Yes” path out of decision block 321), the cursor is then removed (step 323) and operation of the device 200 is controlled by the activated function.

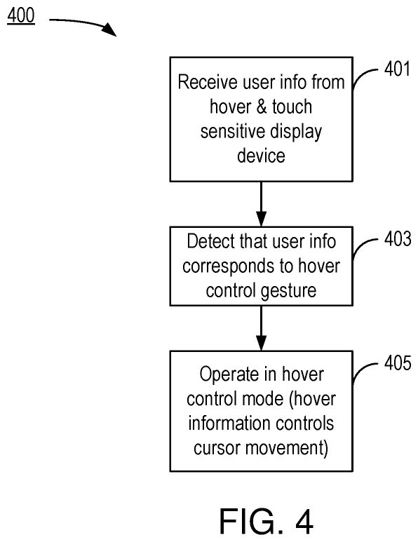

Broad aspects of some but not necessarily all inventive embodiments are now described with reference to FIG. 4, which is in one respect a flowchart of actions taken by the device 200 while in a hover control mode that enables one-handed operation of the device 200. In other respects, the blocks depicted in FIG. 4 can also be considered to represent means 400 (e.g., hardwired or programmable circuitry or other processing means) for carrying out the described actions.

At step 401, the device 200 receives user information from the hover and touch sensitive display device 101, 201. The device detects (step 403) that the received information corresponds to a hover control gesture, wherein the hover control gesture comprises a swipe gesture followed by hover information. In response to said detecting, the device is operated in a hover control mode (step 405) that comprises using continuously supplied hover information to control placement of a cursor display on the hover and touch sensitive display device.

An aspect illustrated in each of the above-described embodiments involves the need to be able to determine when an object 101 (e.g., thumb or other finger) is lifted from the hover and touch sensitive display device 103, 203, and also to get a measurement of the object's distance from the touch screen. The distance measurement does not need to measure exactly the same from one session to another because it is believed a measurement difference at least up to 10% will not impact the user experience. Accurate measurement of changes in distance are more important within the context of a single one-handed operation session. Such measurements can be obtained in any of a number of ways, including but not limited to the following described embodiments.

Regarding the ability to detect if there is something touching a surface, many different technologies can be used. The most common technology is capacitive sensing which is used as touch input in most smart devices today. This type of technology measures the change in capacitance when a finger or other conductive material is close to the capacitive sensing sensor. There are different technologies within the capacitive sensing such as surface capacitance and projected capacitance, the latter including self-capacitance and mutual capacitance technologies which are the once most commonly used technologies for detecting touch in smart devices. Capacitive sensing is the main technology for detecting when a thumb or other conducting object is touching the surface of the device. Examples of other technologies that can be used to detect touch on the surface are optical, acoustic and resistive technologies.

Capacitive sensing can also be used to detect when an object moves from the surface into the air above. The capacitive sensing will detect when the thumb leaves the surface.

One of the least complex solutions for use with inventive embodiments is to continue to use capacitive sensing because the touch sensor is able to also detect when a finger is in the air above the surface. It is used for example in a feature called glove mode that enable the touch sensor to detect a finger when using gloves (i.e., detecting when the finger is not touching the surface but is a bit above the surface). Although this solution is simple, it brings along the problem of not being very accurate from one session to another due to different noise levels in the device. As a non-limiting example, it is desired for the technology to work well up to 30-40 mm from the surface of the device 200, with a variance between one-handed mode sessions. Operation at even higher distances above the surface of the device 200 are also contemplated to be within the scope of inventive embodiments. Regarding distances above the surface of the device 200, it is noted that when the tip of the thumb is raised, the base of the thumb becomes closer to the device surface than the than the tip (or at least top part) of the thumb. Of relevance with respect to inventive embodiments is the distance of the top (or top part of the thumb). Technologies presently exist that are capable of distinguishing between the two, and such technologies should be engaged as part of inventive embodiments in order to detect the height of the tip (or top part) of the thumb in order to obtain the best performance.

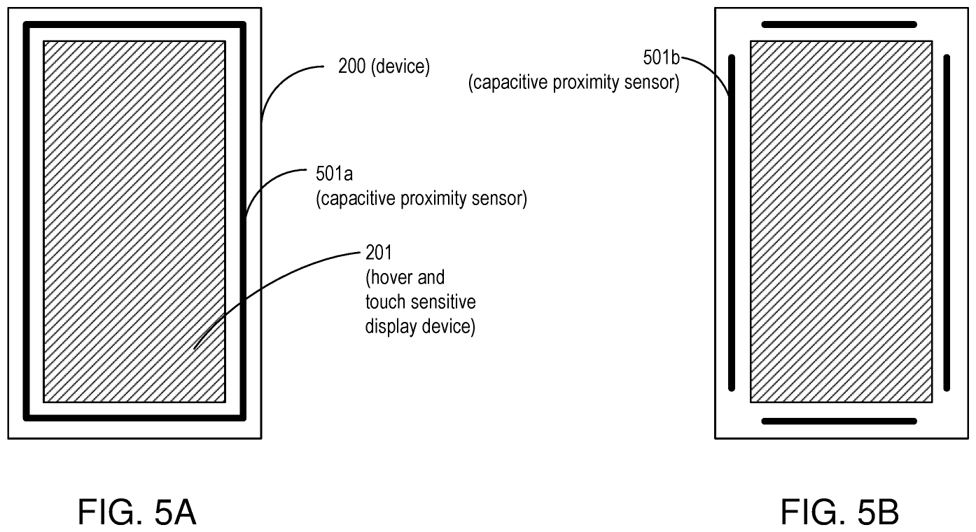

Another solution is to use a dedicated capacitive proximity sensor. All major capacitive touch IC vendors a have a solution to enable this. As shown in the alternative embodiments of FIGS. 5A and 5B, one or more touch areas are defined as the capacitive proximity sensor 501a, 501b and are connected to a touch IC. This can be the same touch IC that controls the surface sensing. To be able to get 3D resolution when moving a conductive object in the air, one sensor on each side of the screen is needed.

As an alternative to capacity sensing, radar technology can be used to enable in-air sensing. There are presently several different radar components that work in tens of GHz spectrum that can be used to get very good resolution. One way of deploying this solution is to include a radar IC that is connected to one or several antennas. Based on the reflection (Rx signal) received back from a transmitted signal (Tx signal), the IC calculates position and/or if a gesture is performed. This technology is very accurate and is able to detect millimeter movement with high accuracy in the 3D space.

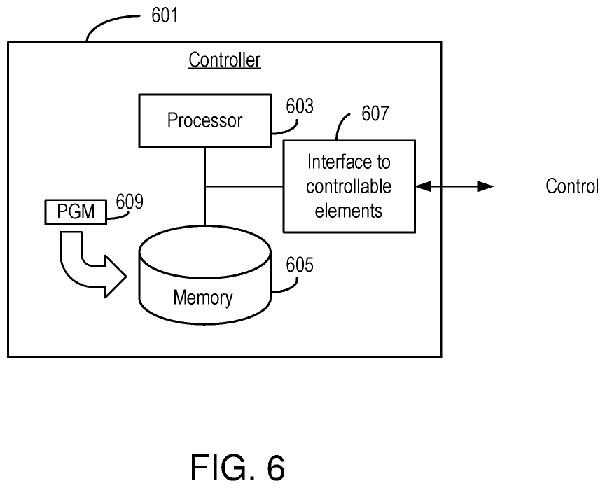

Aspects of an exemplary controller 601 that may be included in the device 201 to cause any and/or all of the above-described actions to be performed as discussed in the various embodiments are shown in FIG. 6, which illustrates an exemplary controller 601 of a device 2011 in accordance with some but not necessarily all exemplary embodiments consistent with the invention. In particular, the controller 601 includes circuitry configured to carry out any one or any combination of the various functions described above. Such circuitry could, for example, be entirely hard-wired circuitry (e.g., one or more Application Specific Integrated Circuits—“ASICs”). Depicted in the exemplary embodiment of FIG. 6, however, is programmable circuitry, comprising a processor 603 coupled to one or more memory devices 605 (e.g., Random Access Memory, Magnetic Disc Drives, Optical Disk Drives, Read Only Memory, etc.) and to an interface 607 that enables bidirectional communication with other elements of the device 201. The memory device(s) 605 store program means 609 (e.g., a set of processor instructions) configured to cause the processor 603 to control other system elements so as to carry out any of the aspects described above. The memory device(s) 605 may also store data (not shown) representing various constant and variable parameters as may be needed by the processor 603 and/or as may be generated when carrying out its functions such as those specified by the program means 609.

A number of non-limiting embodiments have been described that enable one-handed operation of a user device (e.g., a smartphone). The various embodiments involve a combination of on-screen swipe followed by a lifting of the swiping finger above the screen to further control a cursor representing the position of focus on the screen.

Some embodiments additionally involve an activation function that can, for example, be a tapping of any other finger on the device. Various alternative implementations have been described.

Embodiments consistent with the invention are advantageous in a number of respects. A primary advantage is that they enable one-handed touch-controlled operation of even a large handheld device that is being held by the same hand.

Another advantage is that one-handed operation is enabled without needing to scale-down the area of user interaction (both display and touch input). Solutions involving user interface scaling sometimes make only part of the display content visible, and/or they modify the user interface in a non-trivial application-specific way.

The invention has been described with reference to particular embodiments. However, it will be readily apparent to those skilled in the art that it is possible to embody the invention in specific forms other than those of the embodiment described above. Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1. A method of operating a user interface of a device, wherein the user interface comprises a hover and touch sensitive display device, the method comprising:
receiving user information from the hover and touch sensitive display device;
detecting that the received information corresponds to a hover control gesture, wherein the hover control gesture comprises a swipe gesture followed by hover information; and
in response to said detecting, operating the device in a hover control mode that comprises using continuously supplied hover information to control placement of a cursor display on the hover and touch sensitive display device.

2. The method of claim 1, wherein an initial placement of the cursor display following said detecting is a detected location at which a first object performing the swipe gesture lifted off of the hover and touch sensitive display device.

3. The method of claim 1, wherein using the continuously supplied hover information to control placement of the cursor display on the hover and touch sensitive display device comprises:
moving the cursor display in one of two directions along a line of movement in correspondence with a trajectory of the detected swipe gesture, wherein a placement of the cursor display along the line of movement is proportional to a detected height of the first object from the hover and touch sensitive display device.

4. The method of claim 3, wherein the placement of the cursor display along the line of movement is continuously adjusted in correspondence with changes in detected height of the first object from the hover and touch sensitive display device.

5. The method of claim 4, wherein the placement of the cursor display along the line of movement is continuously adjusted further in correspondence with a speed at which detected height of the first object from the hover and touch sensitive display device changes.

6. The method of claim 3, comprising:
detecting that the hover information indicates a movement of the first object parallel to a plane of the hover and touch sensitive display device, and in response thereto adjusting the placement of the cursor display in a direction that is orthogonal to the line of movement.

7. The method of claim 6, wherein adjusting the placement of the cursor display in the direction that is orthogonal to the line of movement comprises adjusting the placement of the cursor display in the direction that is orthogonal to the line of movement by an amount that is proportional to an amount of movement of the object that is parallel to the plane of the hover and touch sensitive display device.

8. The method of claim 3, comprising one of:
estimating the trajectory from input touch information obtained over a predefined distance of the hover and touch sensitive display device; and
estimating the trajectory from input touch information obtained over a predefined period of time.

9. The method of claim 3, comprising:
using radar information to detect the height of the first object from the hover and touch sensitive display device.

10. The method of claim 1, comprising:
while in hover control mode, detecting that the cursor display is pointing to an executable function of the device when a first predefined number of taps on the device by a second object is detected, and in response thereto causing the device to perform the executable function.

11. The method of claim 1, wherein operating the device in the hover control mode is enabled in response to a detection of a predefined enabling user input to the device.

12-15. (canceled)

16. An apparatus for operating a user interface of a device, wherein the user interface comprises a hover and touch sensitive display device, the apparatus comprising:
circuitry configured to receive user information from the hover and touch sensitive display device;
circuitry configured to detect that the received information corresponds to a hover control gesture, wherein the hover control gesture comprises a swipe gesture followed by hover information; and
circuitry configured to operate, in response to said detecting, the device in a hover control mode that comprises using continuously supplied hover information to control placement of a cursor display on the hover and touch sensitive display device.

17. The apparatus of claim 16, wherein an initial placement of the cursor display following said detecting is a detected location at which a first object performing the swipe gesture lifted off of the hover and touch sensitive display device.

18. The apparatus of claim 16, wherein using the continuously supplied hover information to control placement of the cursor display on the hover and touch sensitive display device comprises:
moving the cursor display in one of two directions along a line of movement in correspondence with a trajectory of the detected swipe gesture, wherein a placement of the cursor display along the line of movement is proportional to a detected height of the first object from the hover and touch sensitive display device.

19. The apparatus of claim 18, wherein the placement of the cursor display along the line of movement is continuously adjusted in correspondence with changes in detected height of the first object from the hover and touch sensitive display device.

20. The apparatus of claim 19, wherein the placement of the cursor display along the line of movement is continuously adjusted further in correspondence with a speed at which detected height of the first object from the hover and touch sensitive display device changes.

21. The apparatus of claim 18, comprising:
circuitry configured to detect that the hover information indicates a movement of the first object parallel to a plane of the hover and touch sensitive display device, and in response thereto to adjust the placement of the cursor display in a direction that is orthogonal to the line of movement.

22. The apparatus of claim 21, wherein adjusting the placement of the cursor display in the direction that is orthogonal to the line of movement comprises adjusting the placement of the cursor display in the direction that is orthogonal to the line of movement by an amount that is proportional to an amount of movement of the object that is parallel to the plane of the hover and touch sensitive display device.

23. The apparatus of claim 18, comprising one of:
circuitry configured to estimate the trajectory from input touch information obtained over a predefined distance of the hover and touch sensitive display device; and
circuitry configured to estimate the trajectory from input touch information obtained over a predefined period of time.

24. The apparatus of claim 18, comprising:
circuitry configured to use radar information to detect the height of the first object from the hover and touch sensitive display device.

25. The apparatus of claim 16, comprising:
circuitry configured to detect, while in hover control mode, that the cursor display is pointing to an executable function of the device when a first predefined number of taps on the device by a second object is detected, and in response thereto to cause the device to perform the executable function.

26. The apparatus of claim 16, wherein the circuitry configured to operate the device in the hover control mode is enabled in response to a detection of a predefined enabling user input to the device.

27. The apparatus of claim 17, wherein the circuitry configured to operate the device in the hover control mode is enabled in response to a detection of a predefined enabling user input to the device, and wherein the predefined enabling user input to the device comprises any one or more of:
input generated by a swipe movement from a bottom point to a second point on the hover and touch sensitive display device followed by a second predefined number of taps on the device by a second object;
input generated by a first swipe movement followed by a second swipe movement;
input generated by a predefined movement of the device while maintaining the first object on the hover and touch sensitive display device; and
input generated by analysis of voice input.

28. The apparatus of claim 17, comprising circuitry configured to cause operation of the device to leave the hover control mode in response to a detection that the first object is touching the hover and touch sensitive display device.
